(19) United States
(12) Patent Application Publication
(10) Pub. No.: US 2024/0125178 A1
(43) Pub. Date: Apr. 18, 2024

(54) DOCKING STATION FOR FOLDING ROLLING LADDERS

(71) Applicant: Ballymore Company, Inc., Coatesville, PA (US)

(72) Inventors: William F. Frame, Coatesville, PA (US); John M. Sayles, West Chester, PA (US); Christopher M. Orlando, Media, PA (US)

(21) Appl. No.: 18/486,863

(22) Filed: Oct. 13, 2023

Related U.S. Application Data
(60) Provisional application No. 63/416,508, filed on Oct. 15, 2022.

(51) Int. Cl. E06C 1/397; E06C 1/393; E06C 7/00; E06C 7/18

(52) U.S. Cl. CPC E06C 1/397; E06C 1/393; E06C 7/00; E06C 7/183; E06C 7/182

(57) ABSTRACT

A docking station for a foldable rolling ladder. The docking station has a moveable sled traveling in slots formed therein. The sled has a grip for engaging a ladder. The folding rolling ladder has a rear vertical and a brace that travels up and down the vertical and is pivotably connected to treads of the ladder at an opposite end. The brace has a bracket to engage the grip of the docking station. When the vertical of the ladder engages the sled, via the grip, causes the ladder to be folded into a storage position by the sled traveling within the docking station within and by the docking station and unfolded into a use position.

### CROSS REFERENCE TO RELATED APPLICATIONS

This application claims priority to U.S. Provisional Patent Application Ser. No. 63/416,508 filed Oct. 15, 2022.

### STATEMENT REGARDING FEDERALLY SPONSORED RESEARCH OR DEVELOPMENT

The present invention was not developed with the use of any Federal Funds, but was developed independently by the inventors.

### BACKGROUND

### 1. Field

The Invention relates to a docking station and a rolling ladder configured to be folded into a storage position by the docking station. Accordingly, there is a need for a new and improved powered docking station and a folding ladder that can be folded by inserting the ladder into the docking station and wherein the ladder is folded into a stowed position within and by the docking station.

### SUMMARY

Disclosed herein is a docking station for a foldable rolling ladder. The docking station has a moveable sled traveling in slots formed therein. The sled has a grip for engaging a ladder. The folding rolling ladder has a rear vertical and a brace that travels up and down the vertical and is pivotably connected to treads of the ladder at an opposite end. The brace has a bracket to engage the grip of the docking station. When the vertical of the ladder engages the sled, via the grip, causes the ladder to be folded into a storage position by the sled traveling within the docking station within and by the docking station and unfolded into a use position.

In one form of the invention, the docking station may include a prong for engaging a bracket disposed on an end of the brace to assist in engaging the ladder. In another form, the docking station includes a clamp that secures the ladder to the sled during travel of the sled and releases the ladder when the sled is in the lower position. In addition, the ladder may include foldable handrails.

### BRIEF DESCRIPTION OF THE DRAWINGS

The embodiments will be described in detail with reference to the following drawings in which like reference numerals refer to like elements wherein:

FIG. 1 shows a front perspective view of a docking station and ladder in accordance with the present invention.

FIG. 2 shows a front exploded perspective view of the docking station and ladder of FIG. 1 in a use configuration.

FIG. 3 shows a front exploded perspective view of the docking station and ladder of FIG. 1 with the ladder in a folded configuration.

FIG. 4 shows a front perspective view of the docking station and ladder of FIG. 1 with the ladder folded and stowed in the docking station.

FIG. 5 shows a rear exploded perspective view of the docking station and ladder of FIG. 1 with the ladder in a folded configuration.

FIG. 6 shows a partial front perspective view of the docking station of FIG. 1.

FIG. 7 shows a rear perspective view of the docking station of FIG. 1.

FIG. 8 shows a partial rear perspective view of the docking station taken along line 8 of FIG. 7.

### DETAILED DESCRIPTION

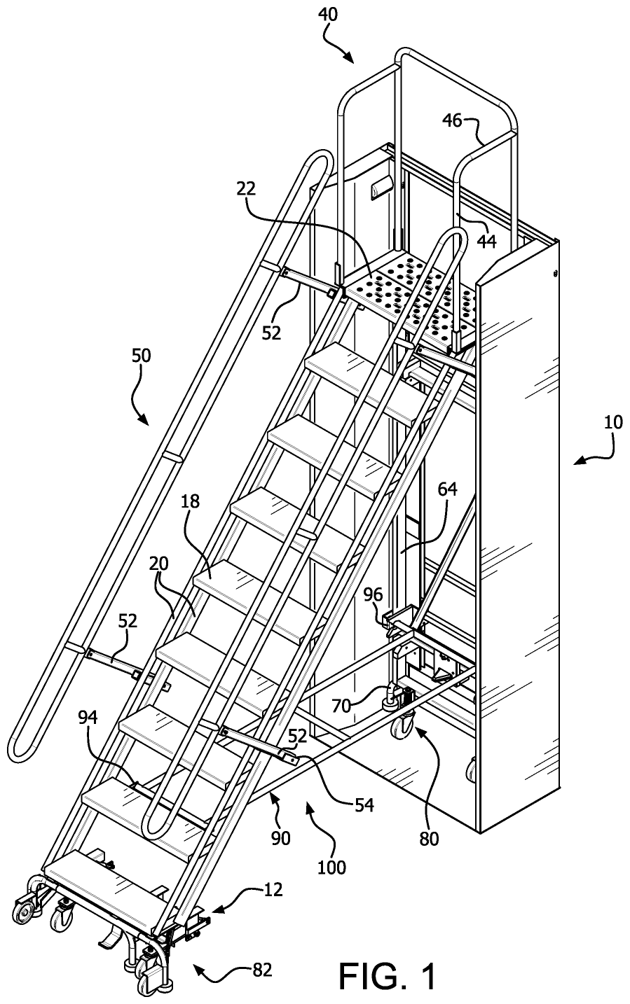

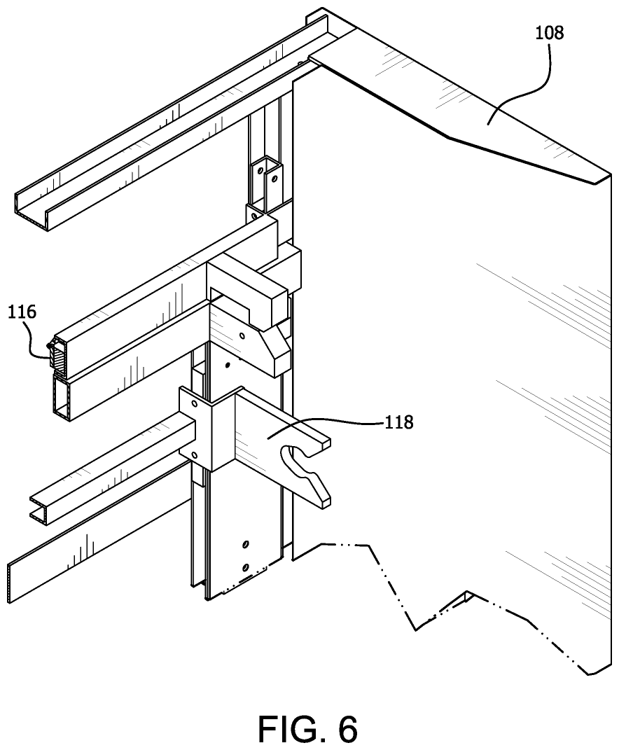

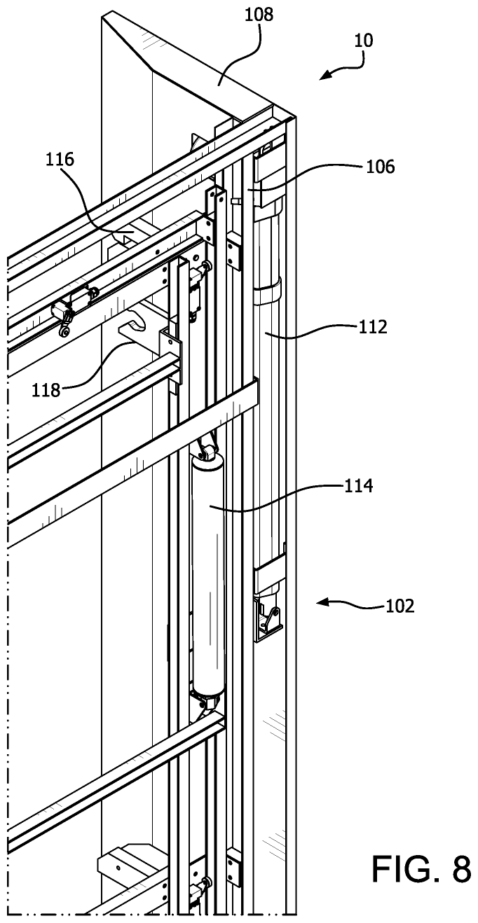

In FIG. 1-8, there is shown a preferred embodiment of a docking station 10 and a folding rolling ladder 100 in accordance with the present invention.

The ladder 100 is configured to be rolled and comprises a base 12 and a stair section 14 attached at its bottom end to the front end of the base. A vertical support 16 connects the top end of the stair section 14 to the back end of the base 12.

The stair section 14 includes a plurality of treads 18 attached to a pair of end rails or stringers 20 forming the stair section and top step or tread 22. Treads are also referred to herein as stairs or steps. The stair section 14 preferably has an elongated parallelogram shape. Preferably, the stair section 14 comprises a substantially one-piece assembly. Preferably, the treads 18 are fixedly attached to the stringers 20 via any suitable means, such as by welding, riveting or the like. The stringers 20 each comprise a top rail 21 and a bottom rail 23.

The top step or tread 22 is attached to the top rail 21 and bottom rail 23 of the end stringers 20. The depth of the top step 22 may be deeper than the remaining steps or treads 18 to facilitate the standing or supporting of an end user or other material to be supported. Typically, the depth of the top step 22 is in the range of about 100% to 300% deeper than the treads 18.

The ladder 100 may also include a top step handrail assembly 40 which encircles the top step 22 on the sides and back. The top step handrail assembly 40 includes a back rail 42 that is typically formed from the top of the vertical support. The top step handrail assembly 40 also includes a front rail 44 that connects to the back rail 42 via a connecting top handrail 46.

A second pair of handrails 50 are connected to the stair section 14 via connecting rails 52 which attach to the top 21 and bottom 23 rails of the stringers 20 via brackets 54 and using suitable fasteners, such as bolts and locknuts.

The front of the ladder 10 may be provided with a locking step assembly 82 which permits travel of the ladder of the ladder as well as for providing a non-rolling support when desired.

The vertical support 16 comprises a cross brace 62 which connects two upright vertical rails 64, as well as an intermediate horizontal cross rail 66 and a lower cross rail 67 which also connect the vertical rails 64.

A pair of rear feet 70 are attached to the lower cross rail 67.

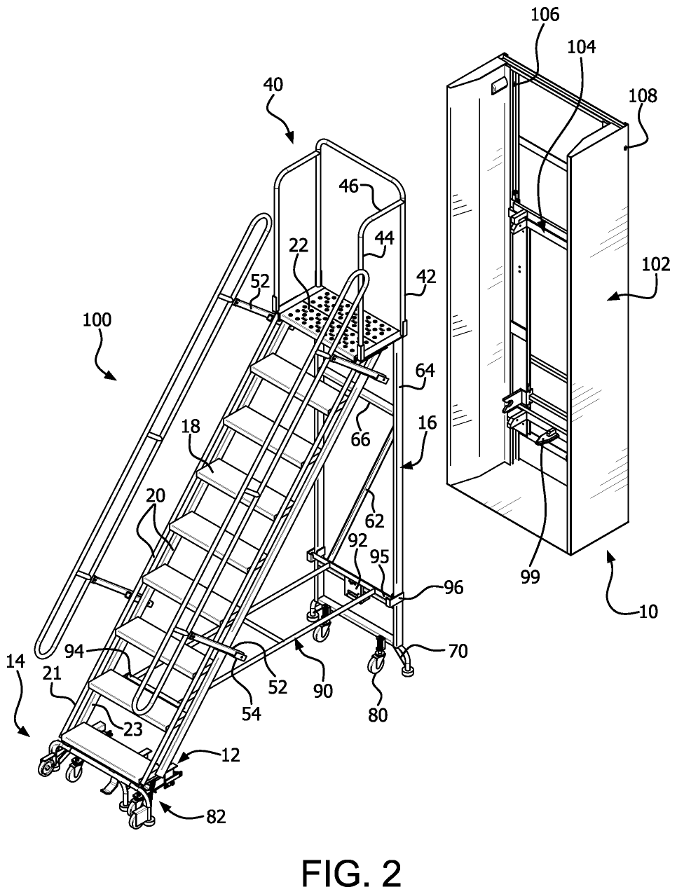

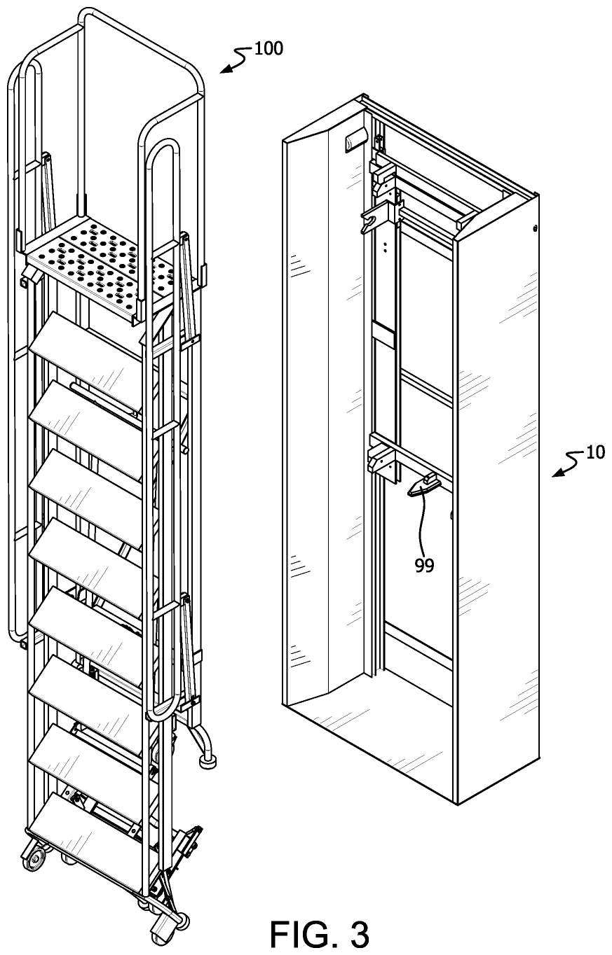

As best seen in FIG. 2, a brace 90 having a pair of members is included to further stabilize the ladder. The brace 90 is attached to the vertical rails 64 via a bracket 92 at one end and pivotably attached at the opposite end 94 to the treads. The bracket 92 comprises a horizontal bar 95 that extends laterally to each side of the ladder 100. At each end of bracket 95 are formed a pair of slides 96 which have an opening for receiving one of the vertical rails 64 of the ladder 100. Such that the slides may travel up and down the vertical rails 64. When the slides 96 travel up the rails 64, this causes the Brace 90 to pivot at end 94, drawing the stair section 14 inwardly and the loader 10 into a folded position. When the slides 96 travel downwardly on the rails 64 the brace rotates downwardly extending the stair section 14 into a use position as shown in FIGS. 2 and 3 for example. When the vertical rails 64 and the brace braces 94 are perpendicular the ladder locks into the use position.

The handrails 50 are collapsible and may include gas springs 52 that hold the handrails 50 in the stowed position and prevent rapid decent of the handrails when they are lowed into the operating position. Gas spring casters 80 may also be employed as described in a co-pending application on even date. In addition, the casters may swivel on all four corners allowing tight turning radii.

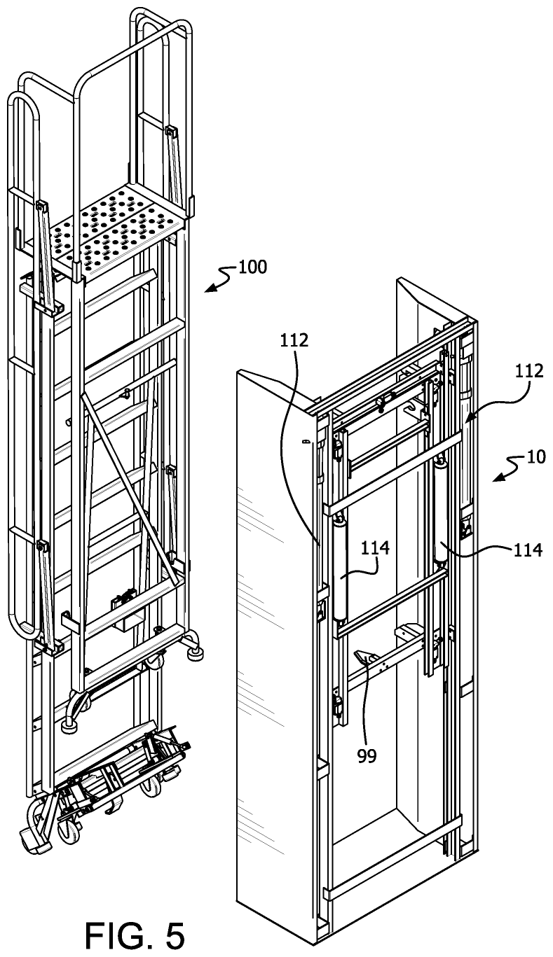

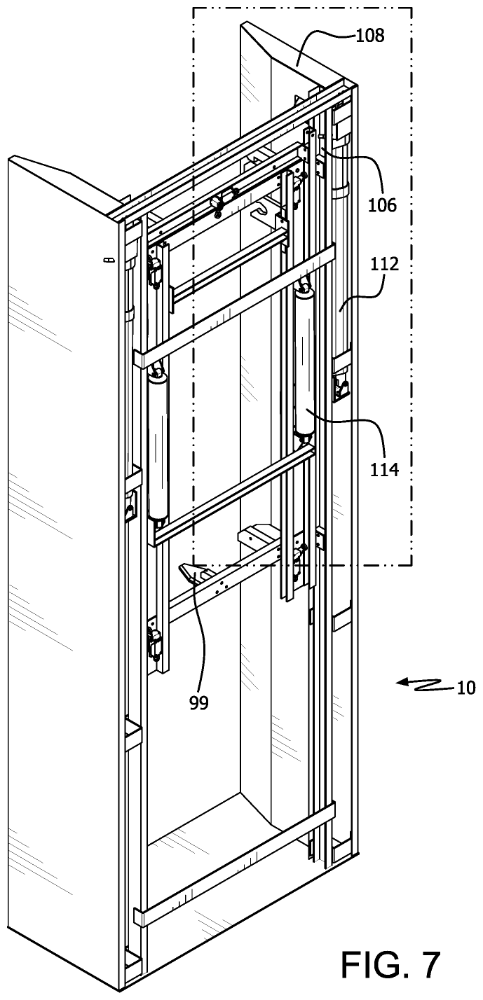

The docking station 10 includes a base 102. The base 102 comprises a pair of side walls 102 and attached to a bottom base portion. The moving sled 104 travels within a slot 106 formed in the vertical walls of the docking station base 102 to travel between an upper position (FIG. 3) to a lower position (FIG. 2). In one preferred embodiment the sled is powered by a motor to move between the upper and lower position. One such motor, a pair of linear actuators 112 are shown in FIGS. 5 and 7. The linear actuators are controlled by the user to extend and contract thus lowered and raising the sled between the raised and lowered positions.

The sled 104 includes a forwardly extending grip 118 having an opening formed therein for engaging cross-bar 95 of the ladder 10. The sled 104 also includes a forwardly extending prong 99 which engages bracket 92 of the ladder 10. Once the ladder is engaged with prong 99 and grip 118 of the sled 104 may be driven by the motor to raise and lower the sled, thus retracting the ladder into a stowed position or extending the ladder into a use position.

A clamp 116 is also formed on the sled 104. The clamp has jaws that engage the ladder when the ladder has contacted the prong 99 and grip 118 of the sled 104 to secure the ladder 10 onto the sled 104. The clamp 116 is driven by a motor, such as linear actuators 114 located on the sled 104. The linear actuators function to close the jaws of the clamp 116 shut on the ladder when engaged.

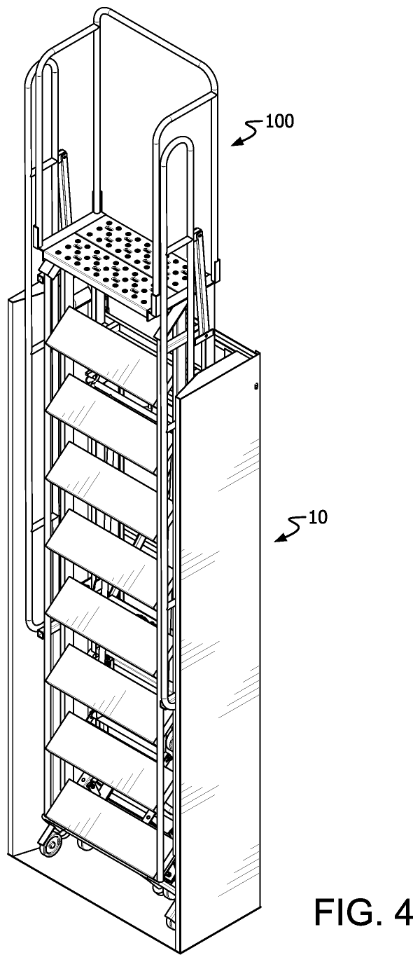

To lift the sled 104, the ladder 100 is inserted into the docking station 10 until the verticals 64 of the ladder 100 engage the prong 99 and grip 118 of the sled 104. Once engaged the jaws of the clamp 116 close on the ladder 100 via actuators 114, securing it to the sled 104. The sled 104 is raised by the control of the operator, As the sled 104 is moved upwardly in the guides 106 via the actuators 114, pulling the end of brace 90 upwardly on the rails 64 of the ladder 100 as its other end 94 pivots, pulling the stair section 14 inwardly until the ladder 100 has been fully collapsed into a folded storage position and retracted into the docking station 10 in the stowed position shown in FIG. 4.

To unstow the ladder 100, the operator activates the actuators 112 to lower the sled 104, unstoiwing the ladder 100 from the docking station 10, as the sled 104 is moved downwardly in the guides 106 via the actuators 114, pulling the end of brace 90 downwardly on the rails 64 of the ladder 100 as its other end 94 pivots, pulling the stair section 14 outwardly until the ladder 100 has been fully opened into an open use position shown in FIG. 2. Once the sled 104 has been fully lowered, the clamp 116 is opened by controlling the actuators 114 to release the ladder 100 from the docking station.

Various sensors for safety and automatic operation are also contemplated as well as an indicator light 108 identifying the state of the docking station.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A docking station and foldable rolling ladder comprising:
a docking station having a moveable sled traveling in slots formed therein, the sled having a grip for engaging a ladder and
a folding rolling ladder having a rear vertical and a brace that travels up and down the vertical and is pivotably connected to treads of the ladder at an opposite end, the brace having a bracket to engage the grip of the docking station, wherein when the vertical of the ladder engages the sled, via the grip, causing the ladder to be folded into a storage position by the sled traveling within the docking station within and by the docking station and unfolded into a use position.

2. The docking station and a foldable rolling ladder according to claim 1 wherein in the docking station further comprises a prong for engaging a bracket disposed on an end of the brace to assist in engaging the ladder.

3. The docking station and a foldable rolling ladder according to claim 1 wherein in the docking station further comprises a clamp that secures the ladder to the sled during travel of the sled and releases the ladder when the sled is in the lower position.

4. The docking station and a foldable rolling ladder according to claim 1 wherein in the ladder further comprises foldable handrails.

5. A docking station for a foldable rolling ladder comprising:
a housing having sidewalls;
a moveable sled traveling in slots formed in the sidewalls;
the sled having a grip for engaging a rear vertical and a brace of a folding ladder, the grip, causing the ladder to be folded into a storage position by the sled traveling within the docking station within and by the docking station and unfolded into a use position.

6. The docking station according to claim 5 wherein in the docking station further comprises a prong for engaging a bracket disposed on an end of the brace to assist in engaging the ladder.

7. The docking station according to claim 5 wherein in the docking station further comprises a clamp that locks and secures the ladder to the sled during travel of the sled and releases the ladder when the sled is in the lower position.
